(19) United States
(12) Patent Application Publication
(10) Pub. No.: US 2020/0160387 A1
(43) Pub. Date: May 21, 2020

(54) SUBSEQUENT OFFER SELECTION BASED ON USER REACTION TO PREVIOUS OFFERS

(71) Applicant: Primer Technologies, Inc., San Francisco, CA (US)

(72) Inventors: Sean Gourley, San Francisco, CA (US); John Bohannon, San Francisco, CA (US)

(21) Appl. No.: 16/426,588

(22) Filed: May 30, 2019

Related U.S. Application Data
(60) Provisional application No. 62/769,449, filed on Nov. 19, 2018.

(51) Int. Cl. G06Q 30/02

(52) U.S. Cl. CPC G06Q 30/0255; G06Q 30/0244; G06Q 30/0269; G06Q 30/0272

(57) ABSTRACT

The technology disclosed herein provides targets offers by selecting a subsequent offer for presentation to a user based on that user's reaction to one or more previously presented offers. In a particular implementation, a method provides, presenting one or more first offers to the user and tracking behavior of the user responsive to being presented with each of the first offers. The method further provides identifying the subsequent offer from a plurality of potential offers based on the behavior and presenting the subsequent offer to the user.

### RELATED APPLICATIONS

This application is related to and claims priority to U.S. Provisional Patent Application No. 62/769,449, titled “SUBSEQUENT OFFER SELECTION BASED ON USER REACTION TO PREVIOUS OFFERS,” filed Nov. 19, 2018, and which is hereby incorporated by reference in its entirety.

### TECHNICAL BACKGROUND

Electronic advertising directed at users is prevalent when operating modern electronic devices. Everything from websites to applications may provide offers to users, such as advertisements informing the user about particular goods or services that the user is able to purchase. The offers may be provided as part of a third-party entity attempting to monetize supplied content (e.g., video, audio, news, game, utility app, etc.) by promoting the products/services of a first-party entity, may be provided by a first-party entity (e.g., to advertise products/services through the first-party entities own website/app) to promote their own goods/services, may be provided by a dedicated electronic advertising device (e.g., a public electronic ad display), or may be provided in some other manner. No matter the manner in which the offers are provided, an offer can be more effective when targeted to a particular user.

### OVERVIEW

The technology disclosed herein provides targets offers by selecting a subsequent offer for presentation to a user based on that user's reaction to one or more previously presented offers. In a particular implementation, a method provides, presenting one or more first offers to the user and tracking behavior of the user responsive to being presented with each of the first offers. The method further provides identifying the subsequent offer from a plurality of potential offers based on the behavior and presenting the subsequent offer to the user.

In some embodiments, presenting the subsequent offer to the user occurs at a first time and the method further provides determining the first time based on the behavior indicating that the user is more receptive to offers presented within a threshold time of the first time.

In some embodiments, presenting the subsequent offer to the user comprises displaying the subsequent offer within content also being displayed to the user and/or audibly presenting the subsequent offer within content being audibly presented to the user.

In some embodiments, the subsequent offer comprises one of an offer for the user purchase a product or an offer for the user to purchase a service.

In some embodiments, tracking the behavior comprises capturing one or more physical cues of the user responsive to being presented with each of the first offers.

In some embodiments, the identifying the subsequent offer comprises, from the behavior, determining one or more reactions of the user to the first offers and selecting the subsequent offer based on the one or more reactions.

In some embodiments, tracking the behavior comprises determining actions performed by the user with a user device after being presented with each of the first offers. One of the actions may include an internet search query related to one or more of the first offers.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to present one or more first offers to the user and track behavior of the user responsive to being presented with each of the first offers. The program instructions further direct the processing system to identify the subsequent offer from a plurality of potential offers based on the behavior and present the subsequent offer to the user.

### BRIEF DESCRIPTION OF THE DRAWINGS

FIG. 1 illustrates a computing environment for selecting a subsequent offer for presentation to a user.

FIG. 2 illustrates an operation of the computing environment to select a subsequent offer for presentation to a user.

FIG. 3 illustrates another computing environment for selecting a subsequent offer for presentation to a user.

FIG. 4 illustrates an operational scenario for selecting a subsequent offer for presentation to a user.

FIG. 5 illustrates another operational scenario for selecting a subsequent offer for presentation to a user.

FIG. 6 illustrates a computing architecture for selecting a subsequent offer for presentation to a user.

### DETAILED DESCRIPTION

Electronic offers are more effective when targeted to the users in which the offers are being presented. That is, an offer is more likely to result in a user acting on the offer (e.g., purchasing a product or service via an entity associated with the offer) when the offer is relevant to the particular user. For example, a retailer would want an offer system to provide an offer for a television, rather than some other product, to a user wanting a new television. Even more so, the retailer would want the offer to be for a television of a type (e.g., size, brand, features, etc.) of interest to the user. The offer systems herein use the behavior of a user after being presented with one or more offers to determine a subsequent offer for presentation to the user.

The behavior of the user indicates whether the offer system is on the right track with the presented offer(s) so that the offer system can adjust the criteria it uses to select a subsequent offer. Continuing the example from above, if the offer system presents the user with an offer for a particular type of television and the user's behavior indicates that the user does not like that type of television, then the offer system will adjust its offer selection criteria accordingly (e.g., the adjusted criteria will indicate not to select offers for televisions of that type). By tracking the user's behavior in response to other offer presentations, the offer system is able to better identify offers of interest to the user than more traditional manners of performing targeted advertising.

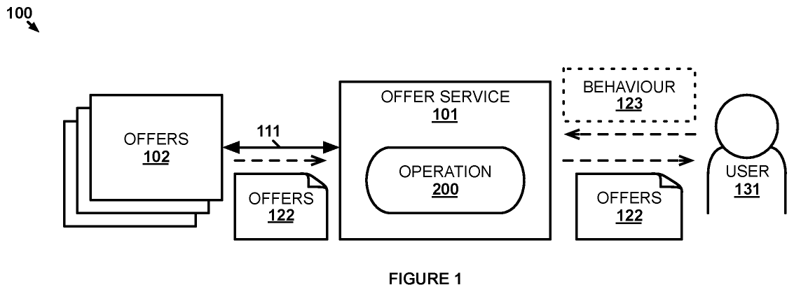

FIG. 1 illustrates computing environment 100 for selecting a subsequent offer for presentation to a user. Computing environment 100 includes offer service 101, which presents one or more offers 122 to user 131. Offer service 101 may be a user device interacting with user 131 directly (e.g., personal computer, tablet, smartphone, information kiosk, advertisement display, etc.), may be a system in connection with a user device operated by user 131 (e.g., a server connected over a communication network), or may be some combination thereof. In operation, offer service 101 maintains offers 102 for presentation to various users, such as user 131. Offers 102 may be presented on behalf of the entity operating offer service 101 or offer service 101 may present offers 102 on behalf of third-party entities. In one example, offer service 101 may provide an online retail website and offers 102 may be for products or services offered by the website. In another example, offer service 101 may be contracted by one or more content providers (e.g., websites, media streamers, application providers, etc.) to provide offers 102 for injection into the content provided by those content providers (e.g., offers before, during, and/or after a video or audio is played or offers displayed on a website, such as a banner ad).

To best target offers to particular users, offer service 101 tracks the behavior of the users in response to being presented with offers of offers 102. The behavior may indicate the users level of interest in the content of an offer, the user's sentiment towards the offer or an entity associated with an offer (e.g., brand, service provider, etc.), the user's understanding of an offer (e.g., the user may be confused about a product's purpose), or some other type of indication as to the user's reaction to an offer. These indications from the behavior of the users allows offer service 101 to adjust how offer service 101 determines which of offers 102 should be presented to the respective users, as described further below. The offers selected by offer service 101 should then be more in-line with what the users would want to receive that would otherwise have been provided.

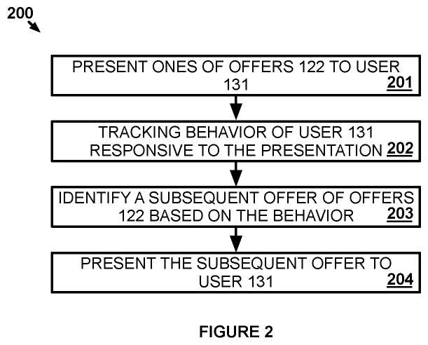

FIG. 2 illustrates operation 200 of computing environment 100 to select a subsequent offer for presentation to a user. Operation 200 describes how offers may be identified and presented to a single user 131, although it should be understood that offers for other users may be identified and presented in a similar manner. In operation 200, offer service 101 presents one or more offers 122 to user 131 (201). These initial one or more offers 122 may have been selected from offers 102 using more traditional manners of selecting offers, including arbitrary or random selection, selection based on a geographic location of user 131, selection based on previous websites visited by user 131, or some other manner in which offer service 101 may select offers without otherwise knowing the behavior of user 131. Offer service 101 may aggregate offers 102 from a plurality of sources making the offers, such as respective data storage repositories for a plurality of retailers, service providers, product manufacturers, etc.—including combinations thereof. Therefore, offers 102 may be retrieved from the respective sources by offer service 101 either upon individual offers being selected for presentation to user 131 or at some other time before presentation to user 131. In some cases, at least a portion of offers 102 may originate in offer service 101. For example, an offer (e.g., visual or audible advertisement) may be created/generated on one or more computing systems within offer service 101 before being stored in a data repository local to offer service 101. In examples where offer service 101 does not have a user interface for user 331 (i.e., does not interact with user 131 directly), offer service 101 presents offers 122 by transferring the subsequent offer to a system with an interface to user 131 for presentation.

After each of the initial one or more of offers 122 are presented, offer service 101 tracks user behavior 123 of user 131 responsive to being presented with each of the offers (202). User behavior 123 may be anything performed by user 131 after user 131 is presented with offers 122, including actions performed by user 131 on a user system operated by user 131 or physical cues produced by user 131 (e.g., audible sounds/speech, facial expressions, hand gestures, or other type of physically produced event that can be captured by a computing device). The behavior may comprise interactions with the offer (e.g., clicking on a banner ad offer) or may comprise interactions outside of the offer itself, including those that would be unrelated. For example, an offer may be for user 131 to purchase art and may include a picture of a beach. User 131 may then take actions such as saying, “I need a vacation” and may perform a web search for best beaches. Both what is said and what is searched for is indicative of user 131 potentially wanting to take a trip to a beach vacation spot.

To collect user behavior 123 when a computing system of offer service 101 is not operated directly by user 131, offer service 101 may have software instructions executing on a user system operated by user 131 (e.g., browser cookie(s), plugin(s), application(s), etc.—including combinations thereof) to capture information about user behavior 123 and transfer it to offer service 101 for processing. The software may monitor input into and output from the user system by user 131 to identify portions of user behavior 123 related to user 131's interactions with the user system. Similarly, the software may be able to track application usage on the user system by interacting with applications executing thereon via an Application Programming Interface (API) of the applications or through other means. The software may also instruct user interface components of the user system, such as one or more cameras, microphones, facial tracking devices, eye tracking devices, etc., to capture physical cues of user 131. Offer service 101 may receive unprocessed data representing user behavior 123 or the user system may determine what behavior at least some of the data indicates before sending to offer service 101. For example, if video is captured of user 131 smiling, offer service 101 may simply receive the video and determine that user 131 is smiling itself or offer service 101 may receive an indication that user 131 is smiling as part of user behavior 123. In the latter example, the video may not be transferred at all as the smiling determination has already been made and indicated to offer service 101.

Offer service 101 identifies a subsequent offer from offers 102 based on user behavior 123 (203). From user behavior 123, offer service 101 determines how user 131 was affected by offers 122. User behavior 123 may indicate one or more emotions felt by user 131 in response to offers 122 (e.g., happy, sad, confused, etc. by offers 122), may indicate one or more opinions of user 131 in response to offers 122 (e.g., dislike, like, love, etc. offers 122 or the subject thereof), may indicate interests of user 131 evoked by offers 122 (e.g., the vacation interest from the example above), or any other type of information. User behavior 123 may apply to each offer as a whole or to individual components of the offer (e.g., user behavior 123 may indicate that user 131 is interested in the service offered but does not like the cost). Moreover, user behavior 123 may apply to characteristics subsidiary to the offer itself, such as a time when the offer was presented, a display location/size of the offer, a length of the offer if a video/audio offer, or some other characteristic.

Offer service 101 then determines an offer from offers 102 to present to user 131 that addresses what offer service 101 has learned from user behavior 123. Offer service 101 may use criteria for selecting ones of offers 102 and may modify that criteria before using the criteria to select the subsequent offer. For instance, if user behavior 123 indicates that user 131 likes a particular brand of product, the criteria may be adjusted to favor that brand. In another example, user behavior 123 may indicate that user 131 likes an offer but finds the offer to be too expensive. Offer service 101 may then adjust criteria to promote selection of a less expensive similar offer (e.g., a particular appliance having similar features but a lower price). Along those same lines, offer service 101 may adjust criteria to select a stronger offer to entice user 131 to accept. For example, one of the initial offers 122 may indicate a 10% off coupon for the user and user behavior 123 may indicate that they are tempted by the coupon but not yet ready to act on the coupon. Offer service 101 may then select an offer of offers 102 having an even larger discount coupon (if one is available) in hopes that user 131 will act on that coupon.

After selecting a subsequent offer for offers 122, offer service 101 presents the subsequent offer to user 131 (204). In examples where offer service 101 does not have a user interface for user 331 (i.e., does not interact with user 131 directly), offer service 101 presents the subsequent offer by transferring the subsequent offer to a system with an interface to user 131 for presentation, such as the system that collected user behavior 123. In some examples, user behavior 123 may indicate that the subsequent offer should be presented in a particular manner (e.g., presented at a certain time during media playback or displayed in a particular screen location). Once the subsequent offer is presented to user 131, offer service 101 may continue to collect user behavior 123 responsive to be presented with that subsequent offer. This allows offer service 101 to continue honing the criteria used for selecting offers for presentation to user 131 enhance the effectiveness of those offers over time.

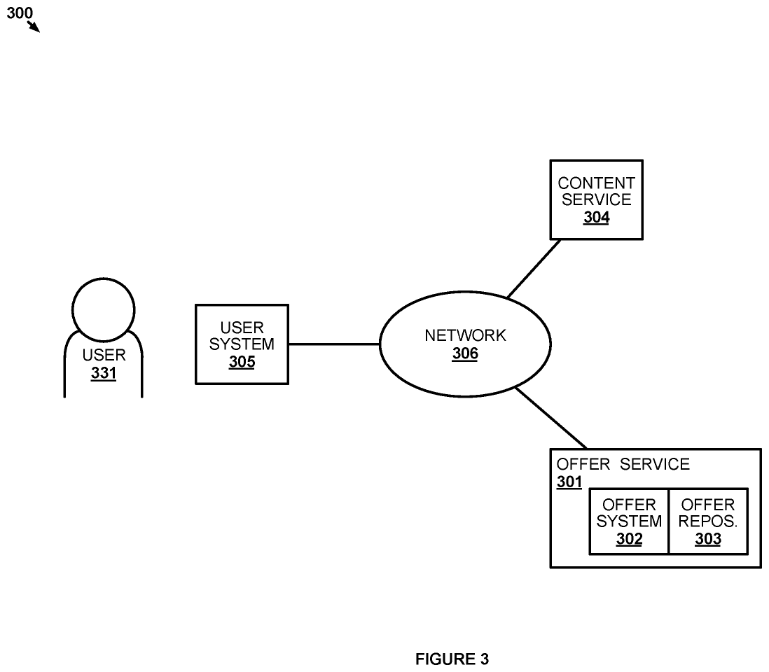

FIG. 3 illustrates computing environment 300 for selecting a subsequent offer for presentation to a user. Computing environment 300 includes offer service 301, content service 304, user system 305, and network 306. Offer service 301 includes offer system 302 and offer repository 303. Elements of computing environment 300 exchange communications over network 306, which may include one or more computing local and wide area computing networks, including the Internet. User system 305 is a computing system or device that interacts with user 331 to at least present the offers discussed herein. User system 305 may be a personal computer, tablet computer, smartphone, electronic advertising display, information kiosk, or some other type of computing system.

In this example, content service 304 comprises one or more computing systems that provide content to user systems, such as user system 305, for consumption by users, including user 331. The content may be a website, video media, audio media, or some other type of content that can be delivered between devices over a network—including combinations thereof. Content service 304 is associated with offer service 301 to provide offers to users along with the provided content. For example, the entity operating content service 304 may contract with the entity operating offer service 301 to provide offers with the content provided by content service 304 as a way to generate revenue from content service 304. Offer service 301 may similarly provide offers to other content services as well. In other examples, offer service 301 and content service 304 may be combined as a single service. The offers provided to users in association with content from content service 304 are most effective when targeted to particular users because the chances of a user accepting, or otherwise acting upon, the offer increase when the offer is relevant to the particular user.

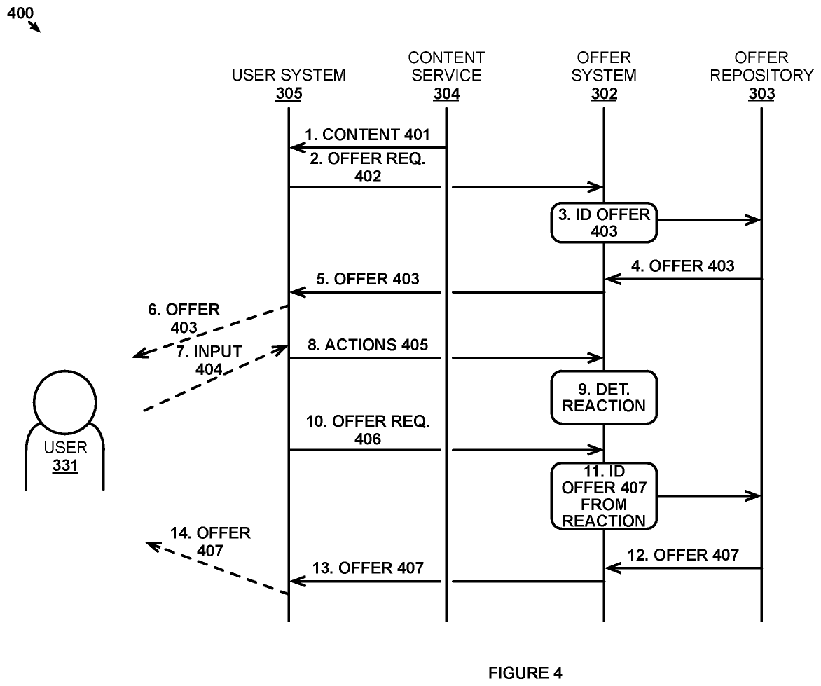

FIG. 4 illustrates operational scenario 400 for selecting a subsequent offer for presentation to a user. Content service 304 presents content 401 by providing content 401 at step 1 to user system 305 so that user system 305 can present content 401 to user 331. User system 305 may immediately present content 401 to user 331 upon receipt or may wait until one or more offers are received to be presented along with content 401. Content 401 may be a website, video, audio, or some other type of content—including combinations thereof. As such, an offer for presentation in association with content 401 may likewise include a video, audio, image, text, or some other type of media—including combinations thereof. For example, if content 401 is a streaming video, then an offer may be a video offer presented before, during, and/or after content 401 is presented. Similarly, audio offers may be presented before, during, and/or after audio content. If the content is a webpage, then the offers may comprise visual advertisements in designated areas of the webpage. Any other manner in which an offer can be provided in association with content may also be used.

In this example, content 401 includes instructions for user system 305 to request an offer directly from offer system 302 for presentation in association with content 401, although, in other examples, content service 304 may itself retrieve offers from offer system 302 and provide the offers along with content 401. User system 305 transfers offer request 402 at step 2 to offer system 302 requesting for offer system 302 to provide an offer for presentation in association with content 401. In response to receiving the request, offer system 302 identifies offer 403 at step 3 from offer repository 303. Since offer system 302 does not yet have any behavior information about user 331 in response to user 331 being presented with other offers, offer system 302 selects offer 403 in a traditional manner (e.g., based on user 331's geographic location or subject matter of content 401). Offer system 302 retrieves offer 403 at step 4 from offer repository 303 and transfers offer 403 at step 5 to user system 305. Upon receiving offer 403, user system 305 presents offer 403 at step 6 to user 331 in association with content 401.

After user system 305 presents offer 403, user 331 provides input 404 at step 7 into user system 305. It should be understood that any time after user system 305 begins to present offer 403 may be considered after user system 305 presents offer 403. User system 305 does not need to complete presentation of offer 403 for input from user 331 to be considered. User input 404 may be of any type, such as mouse clicks, text entry, touchscreen entry, hand gestures, or some other type of input. User input 404 may direct user system 305 to perform any number of actions, such as opening an application, switching between applications, interactions with applications, instructions for user system 305 to perform given tasks, or some other type of action that a user may be capable of initiating via input into user system 305. Actions 405 that are performed in response to user input 404 are considered the behavior of user 331 in response to being presented with offer 403. User system 305 notifies offer system 302 of actions 405 at step 8.

In some examples, actions 405 may be a subset of the actions performed by user 331 after being presented. In these examples, user system 305 may exclude actions determined not to be related to offer 403 from inclusion in actions 405. For instance, an email may be received by user system 305 during presentation of offer 403 and input by user 331 to read/respond to that email may be excluded as likely not being related to offer 403. In other examples, user system 305 include all actions in actions 405 and rely on offer system 302 to determine which of actions 405 are likely related to offer 403.

From actions 405, offer system 302 determines a reaction of user 331 at step 9 to being presented with offer 403. Any number of reactions may be determined depending upon actions 405. The possible reactions may include happiness for offer 403, confusion by offer 403, anger towards offer 403, interest for offer 403 or something related to offer 403 (e.g., a similar product or service), interest for something else that could reasonably have been evoked by offer 403 (e.g., the beach vacation example from above). In one example, actions 405 may include text-based messages (e.g., email, instant messaging, etc.) to another user from which offer system 302 recognizes key words/phrases that relate to offer 403. The key words/phrases may be automatically determined by offer system 302 through analysis of offer 403 or offer 403 may be stored in offer repository 303 in association with metadata that includes key words/phrases for offer system 302 to recognize. From text-based messages, offer system 302 may recognize other text, graphics (e.g., emojis or pictures), or other type of communications that provide context indicating user 331's reaction to offer 403. For example, if offer 403 is an advertisement for a restaurant, user 331 may text a friend asking the friend about whether the friend would like to join user 331 for lunch. This text indicates that user 331 is at least interested in going to lunch at a restaurant, even if it is not specifically the restaurant indicated in offer 403. A similar determination may be made from monitoring a voice or video conversation with similar context. Offer system 302 may include any number of rules or criteria for offer system 302 to follow in order to make various reaction determinations from communications such as the text-based message discussed above.

User system 305 transfers another offer request 406 at step 10 to offer system 302, which requests another offer for presentation to user 331. Offer request 406 may be requesting another offer for presentation in association with content 401 or offer request 406 may be requesting another offer for presentation in association with other content. The other content may be content from content service 304 or may be content from another content service that uses offer service 301 to present offers.

Upon receiving offer request 406, offer system 302 identifies offer 407 at step 11 from the reaction of user 331 to offer 403. Offer system 302 may maintain rules or criteria that offer system 302 should follow to select an offer based on user 331's reaction. Ideally, the reaction allows offer system 302 to narrow the pool of offers available in offer repository 303. For example, if offer 403 was an offer for a consumer electronics store and user 331's reaction to the offer 403 indicated that user 331 has no interest in consumer electronics, then offer system 302 can eliminate consumer electronics related offers for selection of offer 407. In a similar example, user 331's reaction to the consumer electronics retailer of offer 403 may indicate that user 331 is interested in a new television. As such, offer system 302 may select offer 407 from offers for new televisions. In some cases, offer 407 may be a more specific offer related to offer 403. For instance, continuing the previous example, offer 407 may be an offer for a television sold by the consumer electronics retailer of offer 403.

Once selected, offer system 302 retrieves offer 407 at step 12 from offer repository 303 and transfers offer 407 at step 13 to user system 305. Upon receiving offer 407, user system 305 presents offer 403 at step 14 to user 331 in association with content 401 (or whatever content triggered offer request 406). After presenting offer 407, steps 7-9 may be repeated to determine a reaction of user 331 to offer 407 and that reaction may be considered, by itself or in combination with user 331's reaction to offer 403, when offer system 302 identifies a subsequent offer from offer repository 303 for presentation to user 331. The ability to continue considering user 331's reaction to subsequent offers allows offer system 302 to hone its ability to select an offer that is most relevant to user 331.

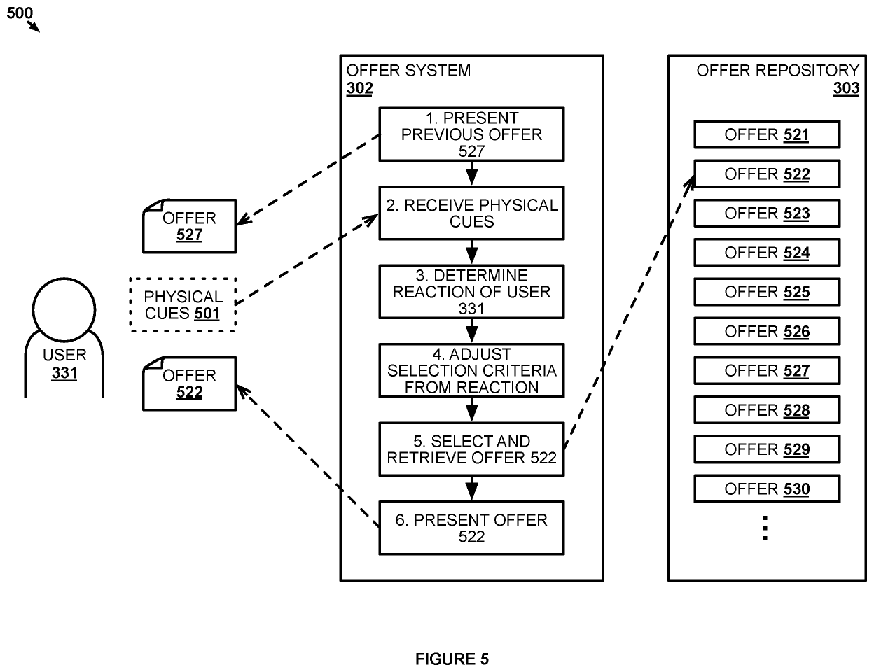

FIG. 5 illustrates operational scenario 500 for selecting a subsequent offer for presentation to a user. Operational scenario 500 is another example of the operation of offer system 302 and offer repository 303 from computing environment 300. In this example, offer system 302 presents offer 527 to user 331 at step 1. While user system 305 is not shown in this example, it should be understood that user system 305 is used by offer system 302 to present offer 527 in a manner similar to that described for offer 403 and offer 407 in operational scenario 400. Offer 527 is selected by offer system 302 from offers 521-530 stored in offer repository 303. Offer 527 may be selected using default criteria for selecting offers, such as criteria that indicates offer system 302 should select an offer based on user 331's geographic location, based on content being presented to user 331, or based on some other parameter when offer system 302 does not yet have sufficient behavior information for user 331.

Once offer 527 is presented to user 331, offer system 302 begins receiving information indicative of user 331's behavior in response to being presented with offer 527. In this example, that behavior information takes the form of physical cues 501 received at step 2. Physical cues 501 may be captured of user 331 via one or more microphones and/or cameras of user system 305, although other types of user capture elements may be employed as well, such as facial detection components. Physical cues 501 may include facial expressions, body language, words spoken by user 331, sounds made by user 331, or some other type of information that can be captured from user 331's person. In examples where offer 527 is a visual offer, such as a video or graphical advertisement, eye tracking in user system 305 may be employed to determine whether user 331 actually viewed the display of offer 527 by user system 305. Physical cues captured when user 331 has yet to actually view offer 527 could then be ignored.

From physical cues 501, offer system 302 determines user 331's reaction at step 3 to the presentation of offer 527. Offer system 302 may include definitions of how various physical cues relate to various user reactions. In a basic example, the definitions may indicate that smiling facial expression indicates that user 331 has a positive reaction to offer 527. In another example, the definitions may indicate that an audible groan from user 331 indicates that user 331 has a negative reaction to offer 527. Of course, more complex definitions may be used as well. In some examples, user 331's speech may be included in physical cues 501 and offer system 302 may therefore parse the speech to determine what user 331 said. The words spoken in that speech may then be analyzed in a manner similar to the text-based message example in operational scenario 400.

Based on user 331's reaction to offer 527, offer system 302 at step 4 adjusts the offer selection criteria to be used for selecting future offers for user 331. The criteria used to select offer 527 may be used as the basis for adjustment or offer system 302 may use one of possibly many other criteria templates that is selected based on the user 331's reaction. As in operational scenario 400, the criteria are adjusted to account for user 331's reaction to offer 527, such as to allow offer selection to take advantage of a favorable reaction or avoid another unfavorable reaction. The criteria may indicate characteristics of offers that should be selected or avoided when identifying offers. The characteristics may include information about the subject matter of the offer, such as product type, particular model of product, service type, brand of product, brand of service, etc. The characteristics may also include information about the offer presentation, such as the display size/shape of a displayed offer, the length of a video or audio offer, the color scheme of an offer, etc. The characteristics of each of offers 521-530 may be stored in association with offers 521-530 in offer repository 303 or may be stored locally in offer system 302.

In one example, user 331's reaction may change over time during the presentation of offer 527. For instance, if offer 527 is a video advertisement, user 331 may have a positive reaction to the offer 527 when offer 527 initially begins to play, which may indicate that user 331 is interested in the product offered by offer 527. However, as the video advertisement continues to display, user 331's reaction may change to annoyed because the video advertisement is too long for user 331's tastes. As such, the criteria may be changed to indicate that user 331 likes the subject matter (e.g., product) of offer 527, so offers for the same or similar products should be selected, but that offers that have a long duration should not be selected.

After adjusting the criteria, offer system 302 uses the criteria at step 5 to select and retrieve another one of offers 521-530 for presentation to user 331. In this example, the criteria leads offer system 302 to select offer 522 for presentation to user 331. Offer 522 is then presented to user 331 via user system 305 and, after which, steps 2-6 may be repeated to collect physical cues from user 331 in response to be presented with offer 522. The criteria used to select offer 522 would then further be adjusted based on user 331's reaction, as determined from those physical cues. An offer subsequent to offer 522 may then be selected based on that further adjusted criteria. Steps 2-6 may then repeat indefinitely.

In some examples, at least some of the criteria used for offer selection may expire or reset after a period of time because user 331's preferences may change over time. For instance, even if user 331 is initially not interested in a carpet cleaning service, user 331 may be interested in such a service at a later date. Therefore, the criteria that directed offer system 302 to not select a carpet cleaning service at one time may expire after an amount of time has elapsed since its creation (e.g., after six months) such that offer system 302 can select a carpet cleaning service offer after the expiration.

It should be understood that, while operational scenario 400 and operational scenario 500 discussed the use of user input and physical cues independently for tracking user 331's behavior, offer system 302 may use user input and physical cues, or any other manner of tracking behavior, in combination. Combining behavior tracking manners increases offer system 302's efficacy when identifying user 331's behavior.

In the above examples, offer system 302 may keep track of user 331 using any manner of user identification. For example, offer system 302 may recognize login credentials of user 331, may perform facial, fingerprint, speech, or some other type of biometric recognition, may assume user system 305 always has the same user (or consider any user of user system 305 to be user 331 since, for example, a family of users may have similar offer interests), or use some other manner of tracking a user. Since the above examples use user 331's behavior to select offers, the user's actual identity does not matter. Offer system 302 need only do its best to ensure the criteria used to select an offer is the criteria associated with the user to which the offer will be presented.

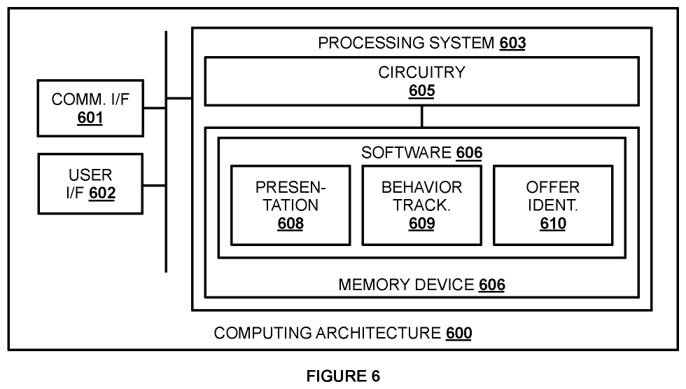

FIG. 6 illustrates computing architecture 600 for selecting a subsequent offer for presentation to a user. Computing architecture 600 is representative of any computing system or systems with which the various operational architectures, processes, scenarios, and sequences disclosed herein for an event summary service may be implemented. Computing architecture 600 is an example of computer systems implementing offer service 101 and offer service 301, although other examples may exist. Computing architecture 600 comprises communication interface 601, user interface 602, and processing system 603. Processing system 603 is linked to communication interface 601 and user interface 602. Processing system 603 includes processing circuitry 605 and memory device 606 that stores operating software 607. Computing architecture 600 may include other well-known components such as a battery and enclosure that are not shown for clarity.

Communication interface 601 comprises components that communicate over communication links, such as network cards, ports, radio frequency (RF), processing circuitry and software, or some other communication devices. Communication interface 601 may be configured to communicate over metallic, wireless, or optical links. Communication interface 601 may be configured to use Time Division Multiplex (TDM), Internet Protocol (IP), Ethernet, optical networking, wireless protocols, communication signaling, or some other communication format—including combinations thereof. In some implementations, communication interface 601 may be configured to communicate with information and supplemental resources to obtain objects for defining events. Communication interface 601 may further be configured to communicate with client or console devices of end users, wherein the users may request and receive summaries from computing system.

User interface 602 comprises components that interact with a user to receive user inputs and to present media and/or information. User interface 602 may include a speaker, microphone, buttons, lights, display screen, touch screen, touch pad, scroll wheel, communication port, or some other user input/output apparatus—including combinations thereof. User interface 602 may be omitted in some examples. In some implementations, user interface 602 may be used in obtaining user summary requests and providing the summary to the requesting user.

Processing circuitry 605 comprises microprocessor and other circuitry that retrieves and executes operating software 607 from memory device 606. Memory device 606 may include volatile and nonvolatile, removable and non-removable media implemented in any method or technology for storage of information, such as computer readable instructions, data structures, program modules, or other data. Memory device 606 may be implemented as a single storage device, but may also be implemented across multiple storage devices or sub-systems. Memory device 606 may comprise additional elements, such as a controller to read operating software 607. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 605 is typically mounted on a circuit board that may also hold memory device 606 and portions of communication interface 601 and user interface 602. Operating software 607 comprises computer programs, firmware, or some other form of machine-readable program instructions. Operating software 607 includes presentation module 608, behavior tracking module 609, and offer identification module 810, although any number of software modules may provide the same operation. Operating software 607 may further include an operating system, utilities, drivers, network interfaces, applications, or some other type of software. When executed by processing circuitry 605, operating software 607 directs processing system 603 to operate computing architecture 600 as described herein.

In one implementation, presentation module 608 directs processing system 603 to present one or more first offers to the user. Behavior tracking module 609 directs processing system 603 to track behavior of the user responsive to being presented with each of the first offers. Offer identification module 610 directs processing system 603 to identify a subsequent offer from a plurality of potential offers based on the behavior. Presentation module 608 then further directs processing system 603 to present the subsequent offer to the user.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method for determining a subsequent offer for presentation to a user, the method comprising:
presenting one or more first offers to the user;
tracking behavior of the user responsive to being presented with each of the first offers;
identifying the subsequent offer from a plurality of potential offers based on the behavior; and
presenting the subsequent offer to the user.

2. The method of claim 1, wherein presenting the subsequent offer to the user occurs at a first time and the method further comprises:
determining the first time based on the behavior indicating that the user is more receptive to offers presented within a threshold time of the first time.

3. The method of claim 1, wherein presenting the subsequent offer to the user comprises:
displaying the subsequent offer within content also being displayed to the user.

4. The method of claim 1, wherein presenting the subsequent offer to the user comprises:
audibly presenting the subsequent offer within content being audibly presented to the user.

5. The method of claim 1, wherein the subsequent offer comprises one of an offer for the user to purchase a product or an offer for the user to purchase a service.

6. The method of claim 1, wherein tracking the behavior comprises:
capturing one or more physical cues of the user responsive to being presented with each of the first offers.

7. The method of claim 1, wherein identifying the subsequent offer comprises:
from the behavior, determining one or more reactions of the user to the first offers; and
selecting the subsequent offer based on the one or more reactions.

8. The method of claim 1, wherein tracking the behavior comprises:
determining actions performed by the user with a user device after being presented with each of the first offers.

9. The method of claim 8, wherein one of the actions performed by the user comprises an internet search query related to one or more of the first offers.

10. An apparatus for determining a subsequent offer for presentation to a user, the apparatus comprising:
one or more computer readable storage media;
a processing system operatively coupled with the one or more computer readable storage media; and
program instructions stored on the one or more computer readable storage media that, when read and executed by the processing system, direct the processing system to:
present one or more first offers to the user;
track behavior of the user responsive to being presented with each of the first offers;
identify the subsequent offer from a plurality of potential offers based on the behavior; and
present the subsequent offer to the user.

11. The apparatus of claim 10, wherein presentation of the subsequent offer to the user occurs at a first time and the program instructions further direct the processing system to:
determine the first time based on the behavior indicating that the user is more receptive to offers presented within a threshold time of the first time.

12. The apparatus of claim 10, wherein to present the subsequent offer to the user, the program instructions direct the processing system to:
display the subsequent offer within content also being displayed to the user.

13. The apparatus of claim 10, wherein to present the subsequent offer to the user, the program instructions direct the processing system to:
audibly present the subsequent offer within content being audibly presented to the user.

14. The apparatus of claim 10, wherein the subsequent offer comprises one of an offer for the user to purchase a product or an offer for the user to purchase a service.

15. The apparatus of claim 10, wherein to track the behavior, the program instructions direct the processing system to:
capture one or more physical cues of the user responsive to being presented with each of the first offers.

16. The apparatus of claim 10, wherein to identify the subsequent offer, the program instructions direct the processing system to:
from the behavior, determine one or more reactions of the user to the first offers; and
select the subsequent offer based on the one or more reactions.

17. The apparatus of claim 10, wherein to track the behavior, the program instructions direct the processing system to:
determine actions performed by the user with a user device after being presented with each of the first offers.

18. The apparatus of claim 17, wherein one of the actions performed by the user comprises an internet search query related to one or more of the first offers.

19. One or more computer readable storage media having program instructions stored thereon for determining a subsequent offer for presentation to a user, the program instructions, when executed by a processing system, direct the processing system to:
present one or more first offers to the user;
track behavior of the user responsive to being presented with each of the first offers;
identify the subsequent offer from a plurality of potential offers based the behavior; and
present the subsequent offer to the user.

20. The one or more computer readable storage media of claim 19, wherein to track the behavior, the program instructions direct the processing system to:
capture one or more physical cues of the user to being presented with each of the first offers.
